(19) United States
(12) Patent Application Publication
(10) Pub. No.: US 2013/0329940 A1
(43) Pub. Date: Dec. 12, 2013

(54) IMAGE PROCESSING APPARATUS, CONTROL METHOD OF IMAGE PROCESSING APPARATUS, AND STORAGE MEDIUM

(71) Applicant: NEC CORPORATION, Tokyo (JP)

(72) Inventor: Yoichi NAKAMURA, Tokyo (JP)

(73) Assignee: NEC Corporation, Tokyo (JP)

(21) Appl. No.: 13/870,699

(22) Filed: Apr. 25, 2013

(30) Foreign Application Priority Data
Jun. 7, 2012 (JP) 2012-129823

(51) Int. Cl. G06K 9/00

(52) U.S. Cl. CPC G06K 9/0063
USPC 382/100

(57) ABSTRACT

An image processing apparatus of the present invention includes: an image quality corrector that performs, when image data of a ground surface image obtained by taking an image of a ground surface from the sky is input, an image quality correction process to bring image quality of a reference image, which is obtained by taking an image of a range overlapping the input ground surface image from the sky, into line with image quality of the input ground surface image; a positioner that positions the input ground surface image and the reference image after the image quality correction process by said image quality corrector is performed; and an image synthesizer that generates a synthetic image by synthesizing the input ground surface image and the reference image after the positioning by the positioner is performed.

### BACKGROUND OF THE INVENTION

1. Field of the Invention

The present invention relates to an image processing apparatus that applies image processing to a ground surface image obtained by taking an image of a ground surface from the sky, a control method of the image processing apparatus, and a storage medium.

2. Description of the Related Art

In recent years, a ground surface image obtained by taking an image of a ground surface from the sky is used in various applications. Image processing may be applied to the ground surface image according to the applications. An example of the image processing applied to the ground surface image includes a synthesis process of positioning ground surface images with overlapping imaging ranges so as to bring reference points into line to thereby synthesize the positioned ground surface images.

The synthesis process is used, among other things, to restore an image of the ground surface corresponding to a cloudy area, in which clouds cover the ground surface so that information related to the ground surface cannot be acquired, when the ground surface image includes the cloudy area.

JP4365887B and JP2001-143054A disclose a technique for extracting a ground surface image, which includes an imaging range that overlaps that of a ground surface image to be restored including a cloudy area and in which the position of the cloudy area is different, as a reference image from ground surface images stored in advance, for positioning the ground surface image to be restored and the reference image, and for generating a synthetic image, in which the image of an area corresponding to the cloudy area is restored, by combining an image of an area in the reference image corresponding to the cloudy area in the ground surface image to be restored and the reference image.

When the ground surface images are synthesized, if the image quality of the ground surface images varies, there is a problem in which the appearance of a synthetic area obtained by synthesizing the ground surface images and the appearance of the other areas in the synthetic image are significantly different. The difference in the image quality between the images to be synthesized is not taken into account in the technique disclosed in JP4365887B and JP2001-143054A.

An object of the present invention is to provide an image processing apparatus that can equalize the image quality of a synthetic image, a control method of the image processing apparatus, and a storage medium.

### SUMMARY OF THE INVENTION

To achieve the above described object, an image processing apparatus according to the present invention comprises:

an image quality corrector that performs, when image data of a ground surface image obtained by taking an image of a ground surface from the sky is input, an image quality correction process to bring image quality of a reference image, which is obtained by taking an image from the sky of a range overlapping the input ground surface image indicated in the image data, into line with the image quality of the input ground surface image;

a positioner that positions the input ground surface image and the reference image after the image quality correction process by the image quality corrector is performed; and an image synthesizer that generates a synthetic image by synthesizing the input ground surface image and the reference image after the positioning by the positioner is performed.

To achieve the object, a control method of an image processing apparatus according to the present invention comprises:

correcting, when image data of a ground surface image obtained by taking an image of a ground surface from the sky is input to said image processing apparatus, image quality by bringing image quality of a reference image, which is obtained by taking an image from the sky of a range overlapping the input ground surface image indicated in the image data, into line with image quality of the input ground surface image;

positioning the input ground surface image and the reference image after the image quality correcting is performed; and

generating a synthetic image by synthesizing the input ground surface image and the reference image after the positioning is performed.

To achieve the object, a storage medium stores a program for causing a computer to execute:

when image data of a ground surface image obtained by taking an image of a ground surface from the sky is input, an image quality correction process of bringing image quality of a reference image, which is obtained by taking an image from the sky of a range overlapping the input ground surface image indicated in the image data, into line with image quality of the input ground surface image;

a positioning process of positioning the input ground surface image and the reference image after the image quality correction process is performed; and

an image synthesis process of generating a synthetic image by synthesizing the input ground surface image and the reference image after the positioning process is performed.

According to the present invention, image quality of a synthetic image can be equalized.

### BRIEF DESCRIPTION OF THE DRAWINGS

FIG. 1 is a block diagram showing a configuration of main parts of an image processing apparatus of an exemplary embodiment of the present invention;

FIG. 2 is a diagram conceptually showing operation of the image processing apparatus shown in FIG. 1; and

FIG. 3 is a diagram conceptually showing operation of the image processing apparatus shown in FIG. 1.

### DETAILED DESCRIPTION OF THE PREFERRED EMBODIMENTS

Exemplary embodiments of the present invention will now be described below with reference to the drawings.

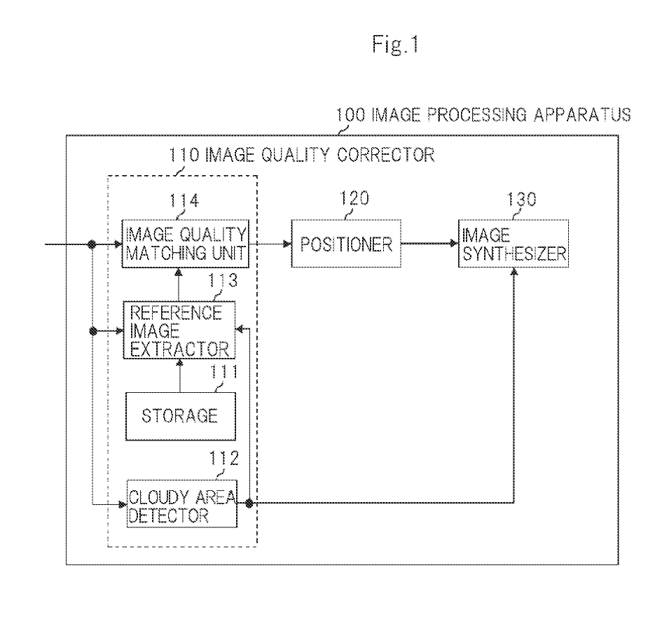

FIG. 1 is a block diagram showing a configuration of main parts of image processing apparatus 100 according to an exemplary embodiment of the present invention.

Image processing apparatus 100 shown in FIG. 1 includes image quality corrector 110, positioner 120, and image synthesizer 130. Image quality corrector 110 includes storage 111, cloudy area detector 112, reference image extractor 113, and image quality matching unit 114.

When image data of a ground surface image and imaging conditions of the ground surface image are input from the outside of image processing apparatus 100, image quality corrector 110 performs an image quality correction process to bring the image quality of the input ground surface image indicated in the image data into line with the image quality of a reference image obtained by taking an image of a range that overlaps that of the input ground surface image from the sky.

Storage 111 stores a ground surface image taken by a camera installed in an artificial satellite in association with imaging conditions of the ground surface image that are input in advance. Examples of the imaging conditions of the ground surface image include imaging date, imaging time, and pointing angle during imaging. The imaging date, the imaging time, the pointing angle during imaging, and the like of the ground surface image can be acquired from telemetry data obtained by monitoring the state of the artificial satellite. Examples of the imaging conditions of the ground surface images also include weather during imaging and the like.

Cloudy area detector 112 detects a cloudy area in the input ground surface image. In general, there is a characteristic in which pixel values in the cloudy area are greater than pixel values in the area where the ground surface is imaged. There is also a characteristic in which change in the pixel values in the cloudy area is smaller than change in the pixel values in the area where the ground surface is imaged. Cloudy area detector 112 binarizes the pixel values of the pixels of the input ground surface image. When an area including the pixels with greater values from among the binary values of the pixel values has an area equal to or greater than a threshold, cloudy area detector 112 detects the area as a cloudy area based on the above characteristics. Cloudy area detector 112 outputs the detection result to reference image extractor 113 and image synthesizer 130.

Among the ground surface images stored in storage 111, reference image extractor 113 extracts, as a reference image, a ground surface image which includes the imaging range that overlaps the imaging range of the input ground surface image and in which the position of the cloudy area is different and the imaging conditions are similar to the imaging conditions of the input ground surface image.

Reference image extractor 113 outputs image data of the extracted reference image to image quality matching unit 114.

Image quality matching unit 114 performs an image quality correction process of the reference image to bring the image quality of the input ground surface image into line with the image quality of the reference image extracted by reference image extractor 113. The image quality of the ground surface image is an index indicating the characteristics of the ground surface image, and examples of the index include an MTF (Modulation Transfer Function) indicating an absolute value of an OTF (Optical Transfer Function) as a two-dimensional Fourier transform of a point spread function of an optical system, a GSD (Ground Sampled Distance) indicating a ground resolution (minimum distance and area that can be identified in the ground surface image), and an SNR (Signal to Noise Ratio) indicating a ratio of the amount of signal and the amount of noise.

In the image quality correction process, image quality matching unit 114 performs an MTF correction process for matching the MTFs, a resampling process for matching the GSDs, a noise adding/removing process for matching the SNRs, and the like. Image quality matching unit 114 further performs a contrast changing process when the dynamic range is different between the pixel values of the input ground surface image and the pixel values of the reference image.

Information related to the image quality of the ground surface image can be obtained from specifications of the camera that has taken the ground surface image or from telemetry data obtained by monitoring the state of the artificial satellite provided with the camera. Therefore, image quality matching unit 114 acquires and uses the specifications of the camera that has taken the ground surface image and the telemetry data obtained by monitoring the state of the artificial satellite provided with the camera to determine various parameters for executing the image quality correction process.

Image quality matching unit 114 performs the MTF correction process as follows, for example. Image quality matching unit 114 first acquires MTF characteristics from the specifications of the camera that has taken the input ground surface image and from the specifications of the camera that has taken the reference image and determines the amount of correction of each frequency for bringing the MTF of the reference image into line with the MTF of the input ground surface image. Image quality matching unit 114 then applies Fourier transform to the reference image, corrects the reference image applied with the Fourier transform based on the determined amount of correction, and performs reverse Fourier transform to thereby acquire the reference image after the MTF correction. Image quality matching unit 114 uses a generally well-known method, such as an NN (Nearest Neighbor) method, a CC (Cubic Convolution) method, and a Lanczos method, to perform a resampling process.

Although an arbitrary image can be used as the reference image as long as the imaging range overlaps that of the input ground surface image and as long as the position of the cloudy area is different, it is desirable to use an image with higher image quality than that of the input ground surface image. If the image quality of the reference image is inferior to the image quality of the input ground surface image, equalization of the image quality is difficult. For example, when the image quality of a low-quality image with a poor MTF is increased, there is a side effect, such as an increase in noise due to the MTF correction process. When an image with a large GSD is converted to an image with a small GSD, the original information of one pixel needs to be converted to information of a plurality of pixels by a resampling process or a super-resolution process, and accurate restoration of the image of the ground surface is difficult. Therefore, it is desirable that the image quality of the reference image be superior to that of the input ground surface image.

Positioner 120 positions the reference image and the input ground surface image after the image quality correction process by image quality matching unit 114 is performed. Specifically, based on a same GCP (Ground Control Point) in the input ground surface image and the reference image, positioner 120 translates or rotates the reference image so as to eliminate the dislocation of the GCP in the images to thereby position the input ground surface image and the reference image. An object that has a distinctive shape, such as a bridge, an intersection of a road, and a cape, is used as the GCP. The same GCP in the input ground surface image and the reference image is selected manually, for example. The GCP in one of the input ground surface image and the reference image may be manually selected, and template matching or the like may be used to automatically select the GCP corresponding to the manually selected GCP from the other image.

Image synthesizer 130 synthesizes the input ground surface image and the reference image after the positioning by positioner 120 to generate a synthetic image is performed. Specifically, image synthesizer 130 replaces the image of the cloudy area in the input ground surface image detected by cloudy area detector 112 by the image of the area, corresponding to the cloudy area, in the reference image after the positioning with the input ground surface image by positioner 120 is performed. The image of the ground surface that corresponds to the cloudy area is restored in the synthetic image by replacing the image of the cloudy area in the input ground surface image with the image of the area in the reference image that corresponds to the cloudy area. The replacement of the image of the cloudy area in the input ground surface image by the image of the area in the reference image corresponding to the cloudy area is performed by providing the pixel values of the pixels in the cloudy area in the input ground surface image with the pixel values of the pixels in the reference image that corresponds to the pixels.

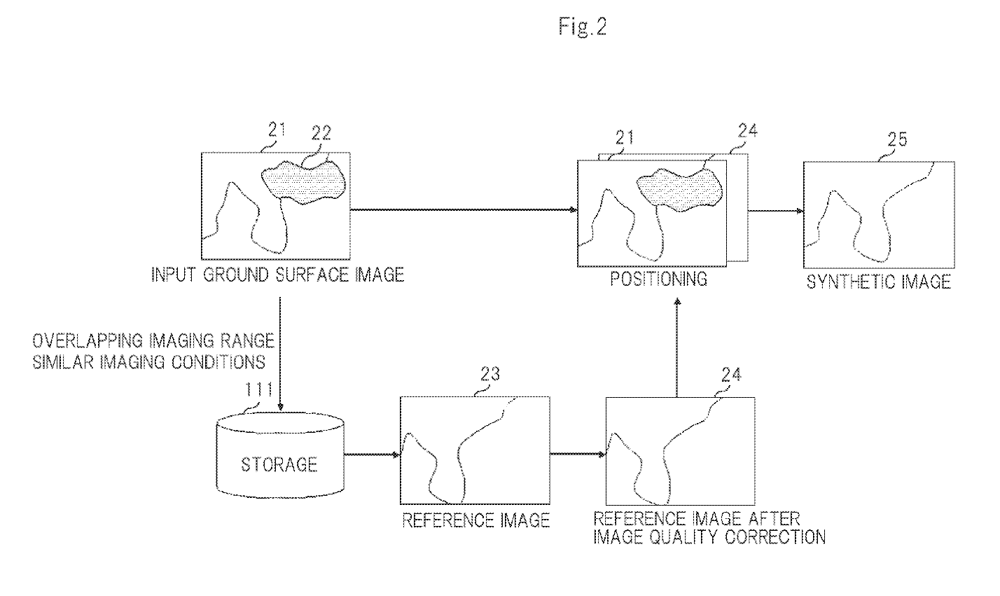

FIG. 2 is a diagram conceptually showing operation of image processing apparatus 100.

It is assumed that image data of input ground surface image 21 shown in FIG. 2 and imaging conditions of input ground surface image 21 are input to image processing apparatus 100.

Cloudy area detector 112 detects cloudy area 22 included in input ground surface image 21.

Among the ground surface images stored in storage 111, reference image extractor 113 extracts, as reference image 23, a ground surface image which includes the imaging range that overlaps that of input ground surface image 21 and in which the position of the cloudy area is different and in which the imaging conditions are similar to those of input ground surface image 21.

If the imaging date of the input ground surface image and the imaging date of the reference image are similar (close), the possibility that there is a difference in the presence/absence of construction of a building on the same imaging range can be reduced. If the imaging time of the input ground surface image and the imaging time of the reference image are close, the difference in the direction of shadows caused by buildings and the like can be reduced. If the pointing angle during imaging of the input ground surface image and the pointing angle during imaging of the reference image are close, the difference in the tilting angle of buildings can be reduced. Therefore, although it is not essential that the imaging conditions of the ground surface image extracted as the reference image are similar to the imaging conditions of the input ground surface image, the similarity is effective in that the difference between the appearance of the synthetic area and the appearance of the other areas in the synthetic image can be reduced.

Image quality matching unit 114 performs an image quality correction process of reference image 23 so as to bring the image quality of reference image 23 into line with the image quality of input ground surface image 21 and generates reference image 24 after the image quality correction process is performed.

Positioner 120 positions input ground surface image 21 and reference image 24 after the image quality correction is performed.

After positioning by positioner 120, image synthesizer 130 replaces an image of a cloudy area in input ground surface image 21 with the image of an area in reference image 24 that corresponds to the cloudy area to generate synthetic image 25.

In this way, according to the exemplary embodiment, image processing apparatus 100 performs the image quality correction process of the reference image so as to bring the image quality of the reference image, which includes the imaging range that overlaps that of the input ground surface image and in which the position of the cloudy area is different and in which the imaging conditions are similar, into line with the image quality of the input ground surface image. Image processing apparatus 100 further positions the input ground surface image and the reference image after the image quality correction process is performed and replaces the image of the cloudy area in the input ground surface image with the image of the area in the reference image that corresponds to the cloudy area to thereby generate the synthetic image.

Therefore, a synthetic image can be generated in which the image of the ground surface that corresponds to the cloudy area is restored. The image quality correction process is applied to the reference image so as to bring the image quality of the reference image into line with the image quality of the input ground surface image, and then the images are positioned and synthesized. This can prevent the synthetic area of the images and the other areas in the synthetic image from having different appearances, and the image quality of the synthetic image can be equalized.

Although an example has been described in the exemplary embodiment in which the ground surface image taken by the camera installed in the artificial satellite is used as the reference image, the arrangement is not limited to this, and a ground surface image taken by a camera installed in an airplane may also be used.

As described above, it is desirable that the image quality of the reference image be superior to the image quality of the input ground surface image in order to accurately restore the image of the ground surface corresponding to the cloudy area of the input ground surface image.

If the ground surface image taken by the camera installed in the artificial satellite is used as the reference image, there is a high possibility that a large number of cloudy areas will be included in the ground surface image when, for example, the ground surface image is taken in a rainy season and that a large number of cloudy areas will be also included in the ground surface image with similar imaging date. Therefore, an appropriate reference image may not be extracted.

The altitude of the airplane is lower than that of an artificial satellite, and the ground surface image can be taken at a lower altitude than the altitude where clouds exist. The ground surface image taken by the camera installed in an airplane flying at a lower altitude than the altitude where clouds exist does not include cloudy areas. Compared to imaging by the camera installed in the artificial satellite, a higher-resolution ground surface image can be acquired by imaging taken by the camera installed in the airplane. Therefore, the ground surface image taken by the camera installed in the airplane can be used as the reference image to more easily and accurately restore the image of the ground surface that corresponds to the cloudy area of the input ground surface image, compared to when the ground surface image taken by the camera installed in the artificial satellite is used as the reference image.

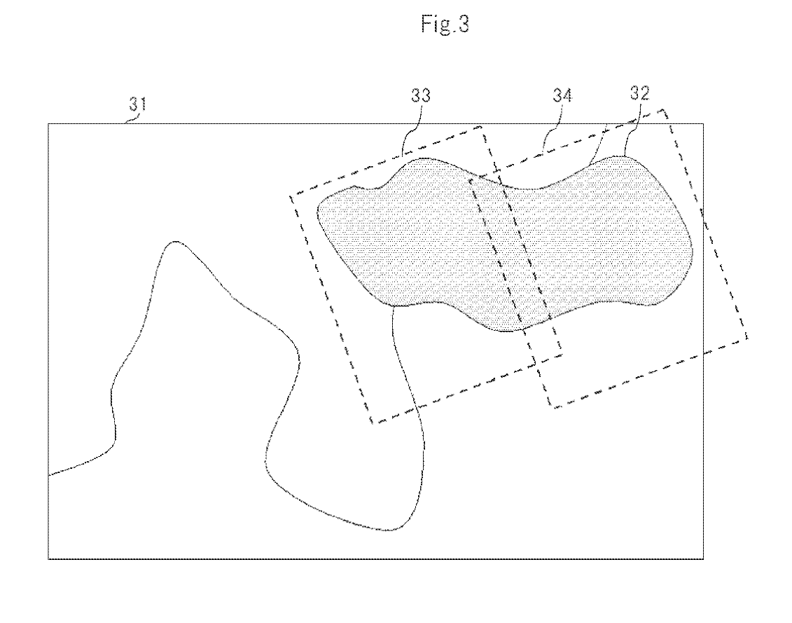

Usually, the imaging range of the ground surface image taken by the camera installed in an airplane is smaller than the imaging range of the ground surface image taken by a camera installed in an artificial satellite. Therefore, to restore the image of the ground surface that corresponds to the cloudy area in the input ground surface image taken by the camera installed in an artificial satellite, a plurality of reference images including the cloudy area in the imaging range may be necessary. In this case, reference image extractor 113 extracts a plurality of reference images so that the entire cloudy area in the input ground surface image is included in the imaging ranges of the reference images as shown in FIG. 3.

In FIG. 3, it is assumed that image data of input ground surface image 31 and imaging conditions of input ground surface image 31 are input to image processing apparatus 100.

Cloudy area detector 112 detects cloudy area 32 included in input ground surface image 31.

Among the ground surface images stored in storage 111, reference image extractor 113 extracts, as a reference image, a ground surface image which includes the imaging range that overlaps that of input ground surface image 31 and in which the position of the cloudy area is different and in which the imaging conditions are similar to the imaging conditions of input ground surface image 31. It is assumed here that two ground surface images 33 and 34 are necessary as shown in FIG. 3 to include entire cloudy area 32. Reference image extractor 113 extracts ground surface images 33 and 34 as reference images. Hereinafter, ground surface images 33 and 34 will be referred to as reference images 33 and 34, respectively.

Image quality matching unit 114 performs the image quality correction process of reference image 33 and reference image 34 to bring the image quality of reference image 33 and reference image 34 into line with the image quality of input ground surface image 31.

Positioner 120 positions input ground surface image 31 and reference images 33 and 34 after the image quality correction is performed.

After positioning by positioner 120, image synthesizer 130 replaces the image of the cloudy area in input ground surface image 31 with the images of the areas in reference image 33 and reference image 34 that corresponds to the cloudy area to generate a synthetic image.

In general, there is a low possibility that the ground surface image taken by the camera installed in the airplane includes the cloudy area, and that the resolution is higher than that of the ground surface image taken by the camera installed in the artificial satellite. Therefore, the ground surface image taken by the camera installed in the airplane can be used as a reference image to easily and accurately generate the synthetic image in which the image of the ground surface that corresponds to the cloudy area is restored and to accurately restore the image of the ground surface that corresponds to the cloudy area of the input ground surface image.

The method executed by the image processing apparatus of the present invention may be applied to a program executed by a computer. The program can be stored in a storage medium and can be provided to the outside through a network.

Part or all of the exemplary embodiment can also be described, without limitation, as in the following appendixes.

### (Appendix 1)

An image processing apparatus comprising:

an image quality corrector that that performs, when image data of a ground surface image obtained by taking an image of a ground surface from the sky is input, an image quality correction process to bring image quality of a reference image, which is obtained by taking an image from the sky of a range overlapping the input ground surface image indicated in the image data, into line with the image quality of the input ground surface image;

a positioner that positions the input ground surface image and the reference image after the image quality correction process by said image quality corrector is performed; and

an image synthesizer that generates a synthetic image by synthesizing the input ground surface image and the reference image after the positioning by said positioner is performed.

### (Appendix 2)

The image processing apparatus according to appendix 1, wherein

said image quality corrector comprises:

a storage that stores ground surface images;

a cloudy area detector that detects a cloudy area in which the ground surface is covered by a cloud, which is included in the input ground surface image;

a reference image extractor that extracts, as the reference image, a ground surface image which includes an imaging range overlapping that of the input ground surface image and in which a position of the cloudy area is different from that of the input ground surface image, from the ground surface images stored in said storage; and

an image quality matching unit that performs an image quality correction process to bring the image quality of the reference image extracted by said reference image extractor into line with the image quality of the input ground surface image, and

said image synthesizer replaces an image of the cloudy area in the input ground surface image detected by said cloudy area detector with an image of an area in the reference image after the positioning by said positioner corresponding to the cloudy area is performed to generate the synthetic image.

### (Appendix 3)

The image processing apparatus according to appendix 2, wherein

said storage further stores an image condition of the ground surface image in association with the ground surface image, and

when the image data of the input ground surface image and the imaging condition of the input ground surface image are input, said reference image extractor extracts, as the reference image, a ground surface image which includes the imaging range overlapping that of the input ground surface image and in which the position of the cloudy area is different and in which the imaging condition is similar to the imaging condition of the input ground surface image, from the ground surface images stored in said storage.

### (Appendix 4)

The image processing apparatus according to appendix 2 or 3, wherein

the ground surface images stored in said storage are ground surface images taken by a camera installed in an airplane.

### (Appendix 5)

The image processing apparatus according to any one of appendixes 1 to 3, wherein

the ground surface images are ground surface images taken by a camera installed in a satellite.

### (Appendix 6)

A control method of an image processing apparatus, the control method comprising:

correcting, when image data of a ground surface image obtained by taking an image of a ground surface from the sky is input to said image processing apparatus, image quality by bringing image quality of a reference image, which is obtained by taking an image from the sky of a range overlapping with the input ground surface image indicated in the image data, into line with image quality of the input ground surface image;

positioning the input ground surface image and the reference image after the image quality correcting is performed; and

generating a synthetic image by synthesizing the input ground surface image and the reference image after the positioning is performed.

### (Appendix 7)

The control method of the image processing apparatus according to appendix 6, wherein

said correcting comprises:

storing ground surface images;

detecting a cloudy area in which the ground surface is covered by a cloud, which is included in the input ground surface image;

extracting, as the reference image, a ground surface image which includes an imaging range overlapping that of the input ground surface image and in which a position of the cloudy area is different from that of the input ground surface image, from the stored ground surface images; and

performing an image quality correction process of bringing the image quality of the extracted reference image into line with the image quality of the input ground surface image, and

in said generating said synthetic image, an image of the cloudy area in the detected input ground surface image is replaced by an image of an area in the reference image after the positioning corresponding to the cloudy area to generate the synthetic image.

### (Appendix 8)

The control method of the image processing apparatus according to appendix 7, wherein

in said storing, an image condition of the ground surface image is further stored in association with the ground surface image, and

in said extracting, when the image data of the input ground surface image and the imaging condition of the input ground surface image are input, a ground surface image, which includes the imaging range overlapping that of the input ground surface image and in which the position of the cloudy area is different and the imaging condition is similar to the imaging condition of the input ground surface image, is extracted as the reference image from the stored ground surface images.

### (Appendix 9)

The control method of the image processing apparatus according to appendix 7 or 8, wherein

the stored ground surface images are ground surface images taken by a camera installed in an airplane.

### (Appendix 10)

The control method of the image processing apparatus according to any one of appendixes 6 to 8, wherein

the ground surface images are ground surface images taken by a camera installed in a satellite.

### (Appendix 11)

A non-transitory computer-readable storage medium recording a program for causing a computer to execute:

when image data of a ground surface image obtained by taking an image of a ground surface from the sky is input, an image quality correction process of bringing image quality of a reference image, which is obtained by taking an image from the sky of a range overlapping the input ground surface image indicated in the image data, into line with image quality of the input ground surface image;

a positioning process of positioning the input ground surface image and the reference image after the image quality correction process is performed; and

an image synthesis process of generating a synthetic image by synthesizing the input ground surface image and the reference image after the positioning process is performed.

What is claimed is:

1. An image processing apparatus comprising:
an image quality corrector that performs, when image data of a ground surface image obtained by taking an image of a ground surface from the sky is input, an image quality correction process to bring image quality of a reference image, which is obtained by taking an image from the sky of a range overlapping the input ground surface image indicated in the image data, into line with the image quality of the input ground surface image;
a positioner that positions the input ground surface image and the reference image after the image quality correction process by said image quality corrector is performed; and
an image synthesizer that generates a synthetic image by synthesizing the input ground surface image and the reference image after the positioning by said positioner is performed.

2. The image processing apparatus according to claim 1, wherein
said image quality corrector comprises:
a storage that stores ground surface images;
a cloudy area detector that detects a cloudy area in which the ground surface is covered by a cloud, which is included in the input ground surface image;
a reference image extractor that extracts, as the reference image, a ground surface image which includes an imaging range overlapping that of the input ground surface image and in which a position of the cloudy area is different from that of the input ground surface image, from the ground surface images stored in said storage; and
an image quality matching unit that performs an image quality correction process to bring the image quality of the reference image extracted by said reference image extractor into line with the image quality of the input ground surface image, and
said image synthesizer replaces an image of the cloudy area in the input ground surface image detected by said cloudy area detector with an image of an area in the reference image after the positioning by said positioner corresponding to the cloudy area is performed to generate the synthetic image.

3. The image processing apparatus according to claim 2, wherein
said storage further stores an image condition of the ground surface image in association with the ground surface image, and
when the image data of the input ground surface image and the imaging condition of the input ground surface image are input, said reference image extractor extracts, as the reference image, a ground surface image which includes the imaging range overlapping that of the input ground surface image and in which the position of the cloudy area is different and in which the imaging condition is similar to the imaging condition of the input ground surface image, from the ground surface images stored in said storage.

4. The image processing apparatus according to claim 2, wherein
the ground surface images stored in said storage are ground surface images taken by a camera installed in on an airplane.

5. The image processing apparatus according to claim 1, wherein
the ground surface images are ground surface images taken by a camera installed in a satellite.

6. A control method of an image processing apparatus, the control method comprising:
correcting, when image data of a ground surface image obtained by taking an image of a ground surface from the sky is input to said image processing apparatus, image quality by bringing image quality of a reference image, which is obtained by taking an image from the sky of a range overlapping with the input ground surface image indicated in the image data, into line with image quality of the input ground surface image;
positioning the input ground surface image and the reference image after the image quality correcting is performed; and
generating a synthetic image by synthesizing the input ground surface image and the reference image after the positioning is performed.

7. The control method of the image processing apparatus according to claim 6, wherein
said correcting comprises:
storing ground surface images;
detecting a cloudy area in which the ground surface is covered by a cloud, which is included in the input ground surface image;
extracting, as the reference image, a ground surface image which includes an imaging range overlapping that of the input ground surface image and in which a position of the cloudy area is different from that of the input ground surface image, from the stored ground surface images; and
performing an image quality correction process of bringing the image quality of the extracted reference image into line with the image quality of the input ground surface image, and
in said generating said synthetic image, an image of the cloudy area in the detected input ground surface image is replaced by an image of an area in the reference image after the positioning corresponding to the cloudy area to generate the synthetic image.

8. The control method of the image processing apparatus according to claim 7, wherein
in said storing, an image condition of the ground surface image is further stored in association with the ground surface image, and
in said extracting, when the image data of the input ground surface image and the imaging condition of the input ground surface image are input, a ground surface image, which includes the imaging range overlapping that of the input ground surface image and in which the position of the cloudy area is different and the imaging condition is similar to the imaging condition of the input ground surface image, is extracted as the reference image from the stored ground surface images.

9. The control method of the image processing apparatus according to claim 7, wherein
the stored ground surface images are ground surface images taken by a camera installed in on an airplane.

10. The control method of the image processing apparatus according to claim 6, wherein
the ground surface images are ground surface images taken by a camera installed in a satellite.

11. A non-transitory computer-readable storage medium recording a program for causing a computer to execute:
when image data of a ground surface image obtained by taking an image of a ground surface from the sky is input, an image quality correction process of bringing image quality of a reference image, which is obtained by taking an image from the sky of a range overlapping the input ground surface image indicated in the image data, into line with image quality of the input ground surface image;
a positioning process of positioning the input ground surface image and the reference image after the image quality correction process is performed; and
an image synthesis process of generating a synthetic image by synthesizing the input ground surface image and the reference image after the positioning process is performed.
